(19) United States
(12) Patent Application Publication
(10) Pub. No.: US 2011/0142162 A1
(43) Pub. Date: Jun. 16, 2011

(54) DATA TRANSMITTING METHOD AND DATA TRANSMITTING STRUCTURE

(76) Inventor: JUN-REN SHIH, Hsinchu City (TW)

(21) Appl. No.: 12/968,783

(22) Filed: Dec. 15, 2010

(30) Foreign Application Priority Data
Dec. 16, 2009 (TW) 098143121

(51) Int. Cl. H04L 27/00

(52) U.S. Cl. 375/295

(57) ABSTRACT

A data transmitting structure and a data transmitting method are disclosed. The data transmitting structure includes an input buffer layer and an output buffer layer. The input buffer layer includes N input latches connected sequentially in series. The 1st input latch of the input buffer layer is coupled to a data module. The output buffer layer includes N output latches connected sequentially in series. The 1st output latch of the output buffer layer is coupled to the Nth input latch of the input buffer layer. When the input buffer layer is turned on, the data in the data module are sequentially loaded into the input buffer layer, and then the data in the input latches are sequentially transmitted to the output latches of the output buffer layer. Finally, the data are sequentially transmitted to the Nth output latch of the output buffer layer and outputted from the Nth output latch.

### CROSS-REFERENCE TO RELATED APPLICATION

This application claims priority based on a Taiwanese Patent Application No. 098143121, filed on Dec. 16, 2009, the disclosure of which is incorporated herein by reference in its entirety.

### BACKGROUND OF THE INVENTION

1. Field of the Invention

The present invention relates to a data transmitting method and a data transmitting structure. More particularly, the present invention relates to a data transmitting method and a data transmitting structure that can be applied to source driver circuits.

2. Description of the Prior Art

With the continuous advance in electronic display techniques, numerous varieties of slim panel display devices have already become the core carrier of video multimedia in daily life. For instance, thin film transistor liquid crystal displays (TFT-LCD) and active matrix organic light emitting diode (AMOLED) displays have gradually become the de facto standard nowadays for electronic display apparatuses in home residences, companies, and other places commonly seen with electronic displays.

Driver circuits are a key component important for accurately and instantaneously displaying videos in display devices. In order to achieve stable image displays, the driver circuits read the information for each scan line in advance from their respective scan line buffers, and then sequentially load each scan line information into their pixel loads according to the scan clock signals.

Generally, the source driver circuit of a display apparatus requires a digital data gathering structure to receive video data in serial format, and then to spread the serial data to parallel registers or latches. In practice, the digital data gathering structure has two essential factors. The first factor is the data transmission speed (alternatively represented as clock cycles), and the second factor is the bit count of the transmission packet data (alternatively represented as bandwidth).

An increase in the data transmission speed represents an increase of the transmitted data in a period of time during the data transmission. When the bit count of the transmission packet data is increased, greater amounts of data can correspondingly be transmitted within the same period of time.

FIG. 1 depicts a schematic view of a conventional digital data gathering structure 1. The digital data gathering structure 1 is applicable to source driver circuits by satisfying various information demands to the different scan lines of display devices.

As shown in FIG. 1, the digital data gathering structure 1 includes a plurality of data channels 10. Each of the plurality of data channels 10 corresponds respectively to at least a scan line of a display device. Moreover, the conventional digital data gathering structure 1 has a double gate circuit structure, a structure which is commonly utilized in conventional source driver circuits, i.e. using a single data channel 10 to correspond to two scan lines by time-division multiplex.

As shown in FIG. 1, the digital data gathering structure 1 utilizes a pipeline structure to process data. When the first data and the second data are transmitted through the digital data gathering structure 1 from the data module 2, the first data is firstly stored in the first latch 12, while the second data is stored in the second latch 13. The digital data gathering structure 1 then transmits the first data and the second data of the first layer to the third latch 14 and the fourth latch 15 of the second layer for temporary storage, allowing data module 2 to store subsequent data to the first latch 12 and the second latch 13.

The first data in the third latch 14 and the second data in the fourth latch 15 are, utilizing a multiplexer 16 in a time sharing multiplex manner, simultaneously outputted sequentially to different scan lines of the data channel 10 so that a single data channel 10 of the digital data gathering structure 1 can correspond to two scan lines.

As a result, the first latch 12 and the third latch 14 form one set of signal storage channels while the second latch 13 and the fourth latch 15 form another set of signal storage channels. The multiplexer 16 is utilized to selectively output the signals of one of the sets of signal storage channels by time-division.

Particularly, since the data transmission is performed by buses 17 in prior arts, the number of the signal lines in the buses 17 will be changed according to the number of the bits to be transmitted. In the present embodiment, the bandwidth of one set of the inputted data is 6 bits while the buses 17 between any two components must correspondingly have 6 signal lines.

Hence, on a printed circuit board, the data channels 10 of the digital data gathering structure 1 has two sets of signal storage channels disposed in parallel (e.g., the first latch 12 and the third latch 14, and the second latch 13 and the fourth latch 15). Twelve (6×2) signal lines are required to connect the data module 2 to the first latch 12 and to the second latch 13 of the first layer. Similarly, twelve signal lines are required to connect the first latch 12 and the second latch 13 of the first layer to the third latch 14 and the fourth latch 15 of the second layer. However, as electronic devices scale down in size as well as the ever increasing advancement of high end integrated circuit production processes continues, the wiring gaps between the different electronic components of an integrated circuit have greatly decreased. The limited spacing between numerous parallel signal lines manifests signal interference problems in the form of a signal noise or a loss of signal stability.

In addition, when the digital data gathering structure 1 requires a single data channel 10 to correspond to a plurality of scan lines (for instance, more than two signal lines), the amount of signal lines between the different layers will accordingly increase by multiples. As a result, greater amount of wiring space is required, causing both the area as well as the cost of the circuit chips to increase. Additionally, the structures of the prior arts require inclusion of a time-division multiplexer 16 to perform time divisional multiplexing, increasing the wiring area and cost of the circuit chips as a result.

The present invention provides a data transmitting structure and a data transmitting method applicable to source driver circuits. The present invention allows source driver circuits with limited wiring space to have stable performances, resolving the above mentioned problems.

### SUMMARY OF THE INVENTION

It is an object of the present invention to provide a data transmitting method applicable to a data transmitting structure. The data transmitting structure includes a first latch, a second latch coupled to the first latch, a third latch coupled to the second latch, and a fourth latch coupled to the third latch, wherein the first latch is coupled to a data module.

The data transmitting method of an embodiment of the present invention includes the following steps: turning on the first latch and the second latch; loading a first data from the data module, wherein the first data is transmitted to the second latch via the first latch; turning on the first latch; loading a second data from the data module, wherein the second data is transmitted to the first latch; turning on a third latch and a fourth latch; transmitting the first data in the second latch to the fourth latch via the third latch, and outputting the first data from the fourth latch; turning on the second latch and the third latch; transmitting the second data in the first latch to the third latch via the second latch; and turning on the fourth latch, so that the second data in the third latch is transmitted to the fourth latch and outputted from the fourth latch.

It is another object of the present invention to provide a data transmitting structure coupled to a data module. The data transmitting structure includes a first latch, a second latch, a third latch, and a fourth latch. The data module, the first latch, the second latch, the third latch, and the fourth latch are coupled sequentially in series.

When the first latch and the second latch are turned on, the first data in the data module is loaded into the second latch via the first latch. Immediately afterwards when the first latch is reopened, the second data in the data module is loaded into the first latch. When the third latch and the fourth latch are turned on, the first data in the second latch is transmitted via the third latch to the fourth latch, wherein the fourth latch handles outputting the first data. When the second latch and the third latch are turned on afterwards, the second data in the first latch is transmitted to the third latch via the second latch. The fourth latch is then reopened, receiving and outputting the second data.

It is a further object of the present invention to provide a data transmitting method applicable to a data transmitting structure. The data transmitting structure includes an input buffer layer and an output buffer layer. The input buffer layer includes N input latches sequentially connected in series while the output buffer layer includes N output latches sequentially connected in series, wherein the 1^{st} input latch of the input buffer layer is coupled to a data module and the 1^{st} output latch of the output buffer layer is coupled to the Nth input latch of the input buffer layer.

The data transmitting method of an embodiment of the present invention includes the following steps: turning on the input buffer layer and sequentially loading N sets of data from the data module into the input latches, starting from the Nth input latch to the 1^{st} input latch; controlling the on/off status of the input and output latches to sequentially transmit the N sets of data in the N input latches to the N output latches in the output buffer layer; and sequentially transmitting the N sets of data to the Nth output latch of the output buffer layer, outputting the N sets of data from the Nth output latch.

It is a further object of the present invention to provide a data transmitting structure that is coupled to a data module.

The data transmitting structure of an embodiment of the present invention includes an input buffer layer, and an output buffer layer. The input buffer layer includes N input latches sequentially connected in series, with the 1^{st} input latch of the input buffer layer coupled to a data module. The output buffer layer includes N output latches sequentially connected in series, with the 1^{st} output latch of the output buffer layer coupled to the Nth input latch of the input buffer layer, wherein N is a positive integer.

When the input buffer layer is turned on, N sets of data in the data module are sequentially loaded into the N^{th} numbered latch from the N^{th} input latch to the 1^{st} input latch in the input buffer layer. The N sets of data in the N input latches are then sequentially transmitted to the N output latches of the output buffer layer by turning on or off the input and output latches. The N sets of data are subsequently transmitted sequentially to the N^{th} output latch of the output buffer layer where the data is outputted.

In comparison to the prior arts, the data transmitting method and the data transmitting structure of the present invention utilizes a combination of latches connected sequentially in series and time-divisional control of the on/off status of the individual latches to allow the series structure to emulate a plurality of parallel signal storage channels. Accordingly, the problem of increased signal lines, required for connection between different layers that arises from the situation where a single data channel corresponds to a plurality of scan lines, can be avoided. In addition, by time-divisionally controlling the on/off status of the latches, the effect of time-division output can be achieved without using additional multiplexer circuits. Consequently, the area of circuit chip can be shrunk, the cost of chips lowered, and the stability of the circuit can be increased.

### BRIEF DESCRIPTION OF THE DRAWINGS

FIG. 1 is a schematic view of a conventional digital data gathering structure;

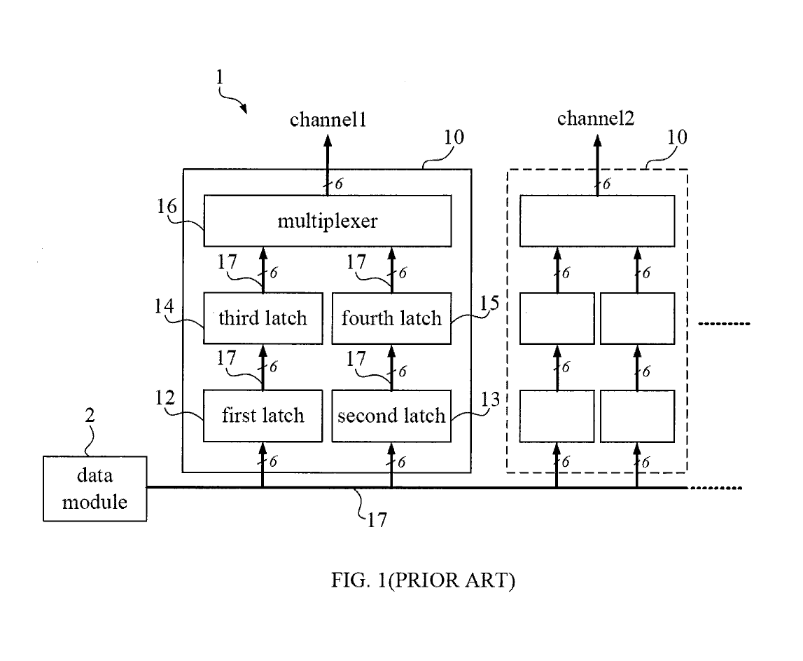

FIG. 2 is a schematic view of a first embodiment of the data transmitting structure of the present invention;

FIG. 3 is a flow chart of a data transmitting method according to an embodiment of the present invention;

FIG. 4 is a schematic view of a second embodiment of the data transmitting structure of the present invention; and

FIG. 5 is a flow chart of a data transmitting method according to an embodiment of the present invention;

### DETAILED DESCRIPTION OF THE PREFERRED EMBODIMENT

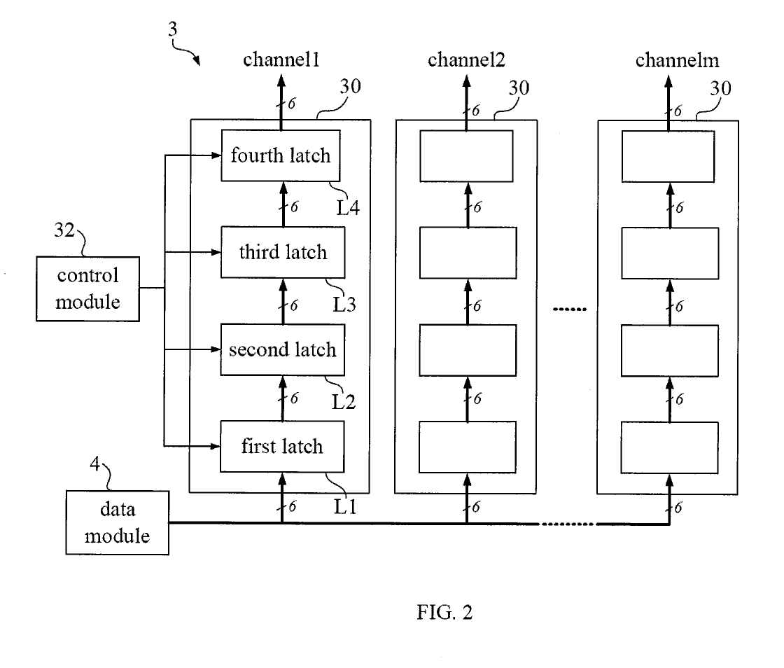

FIG. 2 depicts a schematic view of the first embodiment of the data transmitting structure 3 of the present invention. The data transmitting structure 3 of the present invention can be applied to the source driver circuit of a display device. As shown in FIG. 2, the data transmitting structure 3 includes a plurality of data channels 30. In practice, each data channel 30 corresponds respectively to at least one set of subsequent load circuit (e.g., at least a scan line of the display device). Although in the present embodiment a single data channel 30 corresponds by time-division multiplex to two scan lines of the display device, the present invention does not place a limit to the number of corresponding scan lines thereto.

As shown in FIG. 2, each data channel 30 of the present embodiment includes a first latch L1, a second latch L2, a third latch L3, and a fourth latch L4. The first latch L1, the second latch L2, the third latch L3, and the fourth latch L4 are coupled sequentially in series. The first latch is coupled to the data module 4 while the fourth latch L4 outputs data to two scan lines (not depicted) of the display device. The data transmitting structure 3 reads the video data to be displayed from the data module 4, and transmits the video data to the corresponding scan line, driving the pixel loads of the scan lines to perform the display effect.

As shown in FIG. 2, the data transmitting structure 3 further includes a control module 32 that couples to each of the first latch L1, the second latch L2, the third latch L3, and the fourth latch L4. The control module controls the on/off status of the first latch L1, the second latch L2, the third latch L3, and the fourth latch L4. In general, when a latch is open, data can be loaded into the latch. The loading of the latch may affect the next layer of circuit. When a latch is closed, the latch acts as a temporary storage for the data previously read in and subsequently disallows anymore loading of new data.

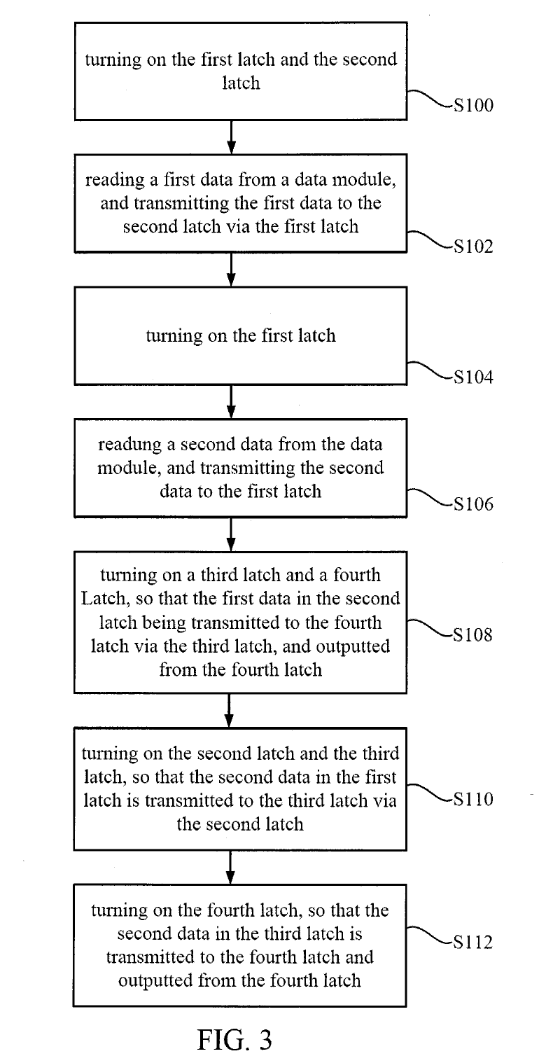

The present invention also provides a data transmitting method for controlling the data transmitting structure 3 to perform the transmission in a time-division multiplex manner. FIG. 3 is a flow chart of a data transmitting method according to an embodiment of the present invention.

What needs to be noted is that a single data channel 30 of the present embodiment corresponds by time-division to two scan lines or alternative subsequent circuits. The data transmitting structure 3 reads a first data and a second data from the data module 4 and outputs them to the scan lines or alternative subsequent circuits.

At first, the data transmitting structure 3 performs step S100 to utilize a control module 32 to open the first latch L1 and the second latch L2. The data transmitting structure 3 then performs step S102 to read the first data from the control module 4, wherein the first data is transmitted to and temporarily stored in the second latch L2 via the first latch L1.

Secondly, the data transmitting structure 3 performs step S104 to utilize the control module 32 to maintain opening the first latch L1 while the second latch L2 returns to the closed status. The data transmitting structure 3 then performs step S106 to read a second data from the data module 4, wherein the second data is transmitted to and temporarily stored in the first latch L1. In the meanwhile, the first data and the second data are respectively loaded into the second latch L2 and the first latch L1 of the data transmitting structure 3.

Then, the data transmitting structure 3 performs step S108 to utilize the control module 32 to open a third latch L3 and a fourth Latch L4, so that the first data in the second latch L2 can be transmitted to the fourth latch L4 via the third latch L3. Consequently, the first data can be outputted to subsequent electronic modules via the fourth latch L4. The data transmitting structure 3 then performs step S110 to utilize the control module 32 to open the second latch L2 and the third latch L3, so that the second data in the first latch L1 is transmitted to the third latch L3 via the second latch L2.

The data transmitting structure 3 can perform step S112 to open the fourth latch L4 after the first data is outputted from the fourth latch L4, so that the second data in the third latch L3 is transmitted to the fourth latch L4. The second data can then be outputted from the fourth latch L4 to subsequent electronic modules.

What needs to be noted is that buses form the connections that couple the first latch L1, the second latch L2, the third latch L3, and the fourth latch L4 of the data transmitting structure 3. The number of signal lines required by each set of bus is proportional to the bandwidth of each set of data. In the mentioned embodiment, the data transmitting method and the data transmitting structure of the present invention include latches connected sequentially in series, wherein the on/off status of each of the latches is controlled by time-division so that the latches connected in series emulate two parallel signal storage channels, thereby satisfying the requirements of two scan lines.

As shown in FIG. 2, under the assumption that each set of data has 6 bits, only one set of bus (i.e. 6 signal lines) is required to be disposed between different layers of latches since the latches are connected sequentially in series. Conversely, limited wiring space due to large amounts of signal lines can be prevented and can allow for the possibility of circuit miniaturation to occur.

The mentioned embodiment demonstrates the data transmitting structure and the data transmitting method of the present invention utilizing the latches disposed in series to emulate two parallel signal storage channels. The data transmitting structure can then by time-division deal with two sets of data to correspondingly drive two sets of load circuits. However, the data transmitting structure and the data transmitting method thereof the present invention are not limited to simultaneously dealing by time-division in parallel with two sets of data. In actuality, the data transmitting structure and the data transmitting method of the present invention can correspond to N sets of data. The following paragraphs disclose an embodiment of the present invention that utilizes a single data channel of the data transmitting structure to deal by time-division in parallel with N sets of data.

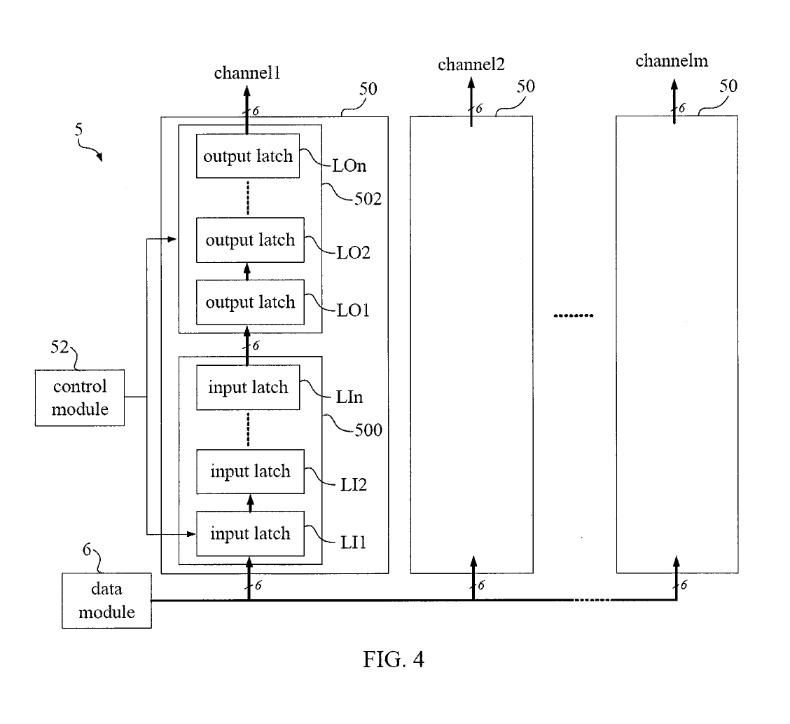

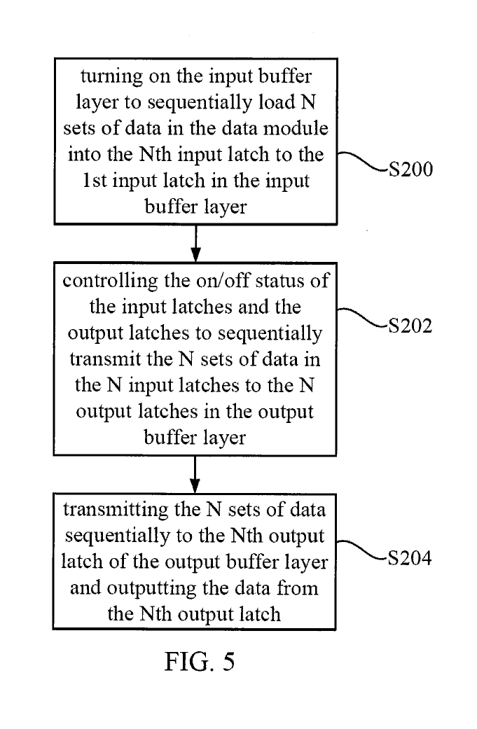

FIG. 4 is a schematic view of the second embodiment of the data transmitting structure 5 of the present invention. FIG. 5 is a flow chart of a data transmitting method, applicable to the data transmitting structure 5.

As shown in FIG. 4, a data transmitting structure 5 is coupled to a data module 6. The data module 6 stores data to be outputted by the data transmitting structure 5. In the present embodiment, the data transmitting structure 5 includes a plurality of data channels 50. Each data channel 50 can by time-division deal in parallel with N sets of data that correspond to N subsequent load circuits, wherein N is a positive integer.

Each data channel 50 includes an input buffer layer 500, and an output buffer layer 502. The input buffer layer 500 includes N input latches (e.g. LI1˜LIn in FIG. 4) sequentially connected in series, and the 1^{st} input latch LI1 of the input buffer layer is coupled to the data module 6. The output buffer layer 502 includes N output latches (e.g. LO1˜LOn in FIG. 4) sequentially connected in series, and the 1st output latch LO1 of the output buffer layer 502 is coupled to the Nth input latch LIn of the input buffer layer 500.

In addition, the data transmitting structure 5 further includes a control module 52. The control module 52 is coupled to the input latches (LI1˜LIn) of the input buffer layer 500 and the output latches (LO1˜LOn) of the output buffer layer 502 so as to control the latches' on/off status.

As shown in FIG. 5, the data transmitting method of the present embodiment first performs step S200, opening the input buffer layer 500 to sequentially load N sets of data from the data module 6 into the input latches in the input buffer layer 500 from the Nth to the 1^{st} input latch.

The process of the mentioned step of S200, wherein N sets of data are sequentially loaded into the input buffer layer 500, can further be precisely described in terms of a single set of data in the N set of data. A set of data from N set of data opens input latches from the 1^{st} input latch to the x^{th} input latch in the input buffer layer 500. The set of data sequentially read through from the 1st input latch to the x−1^{th} input latch and are loaded into the x^{th} output latch, wherein x is a positive integer between 2 and N. When x=1, the first input latch is opened to receive the data.

For instance, when N=4, opening input latches 1 through 4 allows the data to pass through input latches 1 through 3 and then to load into the fourth input latch. Thereafter, input latches 1 through 3 are opened, allowing the data to pass through input latches 1 through 2 and then loading into the third input latch. The process can then be extrapolated until x reaches 0.

Step S202 details controlling the on/off status of the input latches and the output latches to sequentially transmit the N sets of data in the N input latches to the N output latches in the output buffer layer 502.

The mentioned step S202 can be described in more detail as follows. For the set of data in the Nth output latch, output latches 1 through N in the output buffer layer 502 are opened first, allowing data to pass through output latches 1 through N−1 to the Nth output latch.

For other sets of data, input latches x+1 through N in the input buffer layer 500 are opened simultaneously with output latches 1 through X in the output buffer layer 502, allowing the set of data to pass through both input latches x+1 to N and output latches 1 to x−1, and loading into the xth output latch, wherein x is a positive integer between 1 and N−1.

For instance, when N=4, opening output latches 1 through 4 allows the data to pass through output latches 1 to 3, loading into the fourth output latch. Opening the fourth input latch and output latches 1 through 3 allows the data to pass the fourth input latch, through output latches 1 and 2, and loading into the third output latch, etc.

Step S204 details sequentially transmitting N sets of data to the Nth output latch of the output buffer layer 502, where the data are then outputted. In terms of a set of data from the N set of data, opening output latches x+1 through N allows the set of data to pass from output latch x through output latches x+1 to N−1 and load into output latch N, where the data can be outputted.

In summary, the data transmitting method and the data transmitting structure of the present invention utilizes latches sequentially connected in series to control by time-division the on/off status of each individual latch, so that the latches connected in series emulate a plurality of parallel signal storage channels. Consequently, the problem of increased signal lines required to connect different layers when one single data channel corresponds to a plurality of scan lines can be avoided. In addition, by time-divisionally controlling the on/off status of the latches, the effect of time-division output can be achieved without using additional multiplexer circuits. Consequently, the area of circuit chip can be shrunk, the cost of chips lowered, and the stability of the circuit can be increased.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A data transmitting method applied to a data transmitting structure, the data transmitting structure comprising a first latch, a second latch coupled to the first latch, a third latch coupled to the second latch, and a fourth latch coupled to the third latch, wherein the first latch couples to a data module, the data transmitting method comprising:
turning on the first latch and the second latch;
loading a first data from the data module, wherein the first data is transmitted to the second latch via the first latch;
turning on the first latch;
loading second data from the data module, wherein the second data is transmitted to the first latch;
turning on the third latch and the fourth latch;
transmitting the first data in the second latch to the fourth latch via the third latch and outputting the first data from the fourth latch;
turning on the second latch and the third latch;
transmitting the second data in the first latch to the third latch via the second latch; and
turning on the fourth latch, so that the second data in the third latch is transmitted to the fourth latch and outputted from the fourth latch.

2. The method of claim 1, wherein the first latch, the second latch, the third latch, and the fourth latch of the data transmitting structure are coupled by a bus.

3. A data transmitting structure coupled to a data module, comprising:
a first latch coupled to the data module;
a second latch coupled to the first latch;
a third latch coupled to the second latch; and
a fourth latch coupled to the third latch;
wherein when the first latch and the second latch are turned on, first data in the data module is loaded into the second latch via the first latch, second data in the data module is loaded into the first latch after the first latch is turned on again, when the fourth latch and the third latch are turned on afterward, the first data in the second latch are transmitted to the fourth latch via the third latch and outputted from the fourth latch, and when the second latch and the third latch are turned on afterward, the second data in the first latch are transmitted to the third latch via the second latch, and the fourth latch is then turn on again, the second data is transmitted to the fourth latch and outputted from the fourth latch.

4. The data transmitting structure of claim 3, further comprising a control module, wherein the control module couples to the first latch, the second latch, the third latch, and the fourth latch, the control module is configured to turn on/off the first latch, the second latch, the third latch, and the fourth latch.

5. The data transmitting structure of claim 3, wherein the first latch, the second latch, the third latch, and the fourth latch of the data transmitting structure are coupled by a bus.

6. A data transmitting structure coupled to a data module, comprising:
an input buffer layer including N input latches connected sequentially in series, the 1st input latch being coupled to the data module, wherein N is a natural number; and
an output buffer layer including N output latches connected sequentially in series, the 1st output latch of the output buffer layer being coupled to the Nth input latch of the input buffer layer;
wherein when the input buffer layer is turned on, N sets of data in the data module are sequentially loaded into the Nth input latch to the 1st input latch in the input buffer layer and then the N sets of data in the N input latches are sequentially transmitted to the N output latches of the output buffer layer through turning on/off the input latches and the output latches, and then the N sets of data are sequentially transmitted to the Nth output latch of the output buffer layer and outputted from the Nth output latch.

7. The data transmitting structure of claim 6, further comprising a control module, wherein the control module couples to the input buffer layer and the output buffer layer, the control module is configured to turn on/off the input latches and the output latches.

8. The data transmitting structure of claim 7, when one of the N sets of data is loaded into the input buffer layer, the control module turns on the 1st input latch to the xth input latch in the input buffer layer, so that the data get past the 1st input latch to the x−1th input latch to be loaded into the xth output latch, wherein x is an integer between 2 and N.

9. The data transmitting structure of claim 7, when one of the N sets of data is transmitted to the xth output latch of the output buffer layer from the xth input latch of the input buffer layer, the control module simultaneously turns on the x+1th input latch to the Nth input latch in the input buffer layer and the 1st output latch to the xth output latch of the output buffer layer, so that the data get past the x+1th input latch to the Nth input latch and the 1st output latch to the x−1th output latch and are transmitted to the xth output latch, wherein x is a positive integer between 1 and N−1.

10. The data transmitting structure of claim 9, when one of the N sets of data is transmitted from the Nth input latch of the input buffer layer to the Nth output latch of the output buffer layer, the control module turns on the 1st output latch to the Nth output latch of the output buffer layer, so that the data get past the 1st output latch to the N−1th output latch to be transmitted to the Nth output latch.

11. The data transmitting structure of claim 7, the control module turns on the x+1th output latch to the Nth output latch of the output buffer layer before the N sets of data are sequentially outputted from the Nth output latch, so that one set of the data temporarily stored in the xth output latch gets past the x+1th output latch to the N−1th output latch and is outputted from the Nth output latch.

12. A data transmitting method applied to a data transmitting structure, the data transmitting structure including an input buffer layer and an output buffer layer, the input buffer layer including N input latches sequentially connected in series while the output buffer layer including N output latches sequentially connected in series, wherein the 1st input latch of the input buffer layer is coupled to a data module while the 1st output latch of the output buffer layer is coupled to the Nth input latch of the input buffer layer, the data transmitting method comprising:
(a) turning on the input buffer layer to sequentially load N sets of data in the data module into the Nth input latch to the 1st input latch in the input buffer layer;
(b) controlling on/off status of the input latches and the output latches to sequentially transmit the N sets of data in the N input latches to the N output latches in the output buffer layer; and
(c) sequentially transmitting the N sets of data to the Nth output latch of the output buffer layer, and outputting the N sets of data from the Nth output latch.

13. The method of claim 12, wherein the step (a) includes:
(a1) turning on the 1st input latch to the xth latch in the input buffer layer, so that the data get past the 1st input latch to the x−1th input latch to be loaded into the xth output latch, wherein x is a positive integer between 2 and N.

14. The method of claim 12, wherein the step (b), transmitting one of the N sets of data from the xth input latch of the input buffer layer to the xth output latch of the output buffer layer comprises:
(b1) simultaneously turning on the x+1th input latch to the Nth input latch in the input buffer layer and the 1st output latch to the xth output latch in the output buffer layer, so that the data get past the x+1th input latch to the Nth input latch and the 1st output latch to the x−1th output latch to be transmitted to the xth output latch, wherein x is a positive integer between 1 and N−1.

15. The method of claim 12, wherein in the step (b), transmitting one of the N sets of data from the Nth input latch of the input buffer layer to the Nth output latch of the output buffer layer comprises:
(b2) turning on the 1st output latch to the Nth output latch in the output buffer layer, so that the data get past the 1st output latch to the N−1th output latch to be transmitted to the Nth output latch.

16. The method of claim 12, wherein the step (c) comprises:
(c1) turning on the x+1th output latch to the Nth output latch in the output buffer layer, so that one of the N sets of data temporarily stored in the xth output latch gets past the x+1th output latch to the N−1th output latch to be outputted from the Nth output latch.
